(19) United States
(12) Patent Application Publication
(10) Pub. No.: US 2003/0005127 A1
(43) Pub. Date: Jan. 2, 2003

(54) Method and system for the distributed IP object persistent storage in a large scale network

(75) Inventors: Lorin Evan Ullmann, Austin, TX (US); Jason Benfield, Austin, TX (US); Julianne Yarsa, Austin, TX (US); Oliver Yehung Hsu, Austin, TX (US)

Correspondence Address: Anne Vachon Dougherty, 3173 Cedar Road, Yorktown Heights, NY, 10598, US

(73) Assignee: International Business Machines Corporation, Armonk, NY (US)

(21) Appl. No.: 09/896,592

(22) Filed: Jun. 29, 2001

(51) Int. Cl. G06F 15/16; G06F 9/00

(52) U.S. Cl. 709/227

(57) ABSTRACT

A method, system, apparatus, and computer program product for the management of data, objects, and access within a distributed data processing system. The system may comprise a gateway-endpoint organization that allows for a highly distributed service management architecture, wherein services within this framework enable resource consumers to address resources and use resources throughout the distributed system. The distributed-framework routes action objects through the system so that the appropriate gateway receives the action object and ensures its completion and the return of status from its execution. The distributed nature of the gateways and their services allow logical routes to be dynamically determined for the action objects. In particular, the present invention is directed to a plurality of access mechanisms by which distributed services objects and related property data are stored and are accessed within a distributed data processing system. The access mechanisms include an IP Driver IPOP Accessor; a Network Endpoint Locator IPOP Accessor, an Application Properties IPOP Accessor; and an Activator IPOP Accessor.

### FIELD OF THE INVENTION

The present invention relates to an improved data processing system and, in particular, to a method and system for multiple computer or process coordinating for network resource management.

### BACKGROUND OF THE INVENTION

As detailed in co-pending U.S. patent application Ser. No. 09/738,307, filed Dec. 15, 2000, entitled “Method and System for Management of Resource Leases in an Application Framework System”, the teachings of which are incorporated by reference herein, technology expenditures have driven substantial changes in the information technology (IT) arena. Specifically, the IT costs have given rise to an increasing number of outsourcing service providers, each promising, often contractually, to deliver reliable service while offloading the costly burdens of staffing, procuring, and maintaining an IT organization. Service providers optimally employ server outsourcing, application hosting, and desktop management in a large-scela distributed network.

IT solutions now require end-to-end management that includes network connectivity, server maintenance, and application management in order to succeed. Management systems must fulfill two broad goals: a flexible approach that allows rapid deployment and configuration of new services for the customer; and an ability to support rapid delivery of the management tools themselves. A successful management solution fits into a heterogeneous environment, provides openness with which it can knit together management tools and other types of applications, and a consistent approach to managing all of the IT assets. Many service providers have realized the need to scale their capabilities to manage millions of devices. When one considers the number of customers in a home consumer network as well as pervasive devices, such as smart mobile phones, these numbers are quickly realized. Significant bottlenecks appear when typical IT solutions attempt to support more than several thousand devices.

Given such network spaces, a management system should be immune from failure so that service attributes, such as response time, uptime, and throughput, are delivered in accordance with guarantees in a service level agreement. In addition, a service provider may attempt to support as many customers as possible within a single system. Accordingly, the management systems must be able to support granularity on a shared backbone of equipment and services as well as a set of measurements that apply very directly with each customer. By providing this type of granularity, a robust management system can enable a service provider to enter into quality-of-service (QOS) agreements with its customers.

Hence, as noted in the aforementioned patent application, there is a direct relationship between the ability of a management system to provide certain fault-tolerant functionality and the ability of a service provider using the management system to guarantee different levels of service across different platforms. Preferably, the management system can replicate services, detect faults within a service, restart services, and reassign work to a replicated service. By implementing a common set of interfaces across all of their services, each service developer gains the benefits of system robustness.

Distributed data processing systems with thousands of nodes are known in the prior art. The nodes can be geographically dispersed, and the overall computing environment can be managed in a distributed manner. The managed environment can be logically separated into a series of loosely connected managed regions in which each region has its own management server for managing local resources. The management servers coordinate activities across the enterprise and permit remote site management and operation. Local resources within one region can be exported for the use of other regions in a variety of manners.

The aforementioned patent application, provides disclosure of such a distributed network environment, as does another co-pending patent application, U.S. Ser. No. 09/740,088, filed Dec. 18, 2000, entitled “Method and Apparatus for Defining Scope and for Ensuring Finite Growth of Scaled Distributed Applications”, the teachings of which are also incorporated by reference herein. The network includes distributed service functionality, with “distributed access”, via an IP Object Persistent (hereinafter, “IPOP”) Service, to a plurality of network services. A central repository, referred to as the IP Object Persistent (or, hereinafter “IPOP”) Database maintains persistent objects for use by the many network entities.

In order to fulfill QOS guarantees, a management system needs not only to provide an infrastructure by which resources are fairly distributed, but also facilitate access to the available services readily and transparently.

Therefore, it would be particularly advantageous, and is an object of the present invention, to provide a method and system that provides ease of access to distributed network target resources in a fair yet highly distributed manner.

Another object of the invention is that the target resources be dynamically discoverable and flexibly addressable and utilizable.

Yet another object of the invention is to provide distributed service access mechanisms as command line interfaces as well as graphical user interfaces.

Still another object of the invention is to facilitate the retrieval and updating of data to IP network resources in a large-scale distributed network.

### SUMMARY OF THE INVENTION

The foregoing and other objects are realized by the present method, system, apparatus, and computer program product for the management of data, objects, and access within a distributed data processing system. The system may comprise a gateway-endpoint organization that allows for a highly distributed service management architecture. Services within this framework enable resource consumers to address resources and use resources throughout the distributed system. The application framework is preferably implemented in an object-oriented manner. Resources are represented as objects. A request for a target resource is handled by at least one “accessor” through which a requester obtains server service access and server-connected database access by which a connection is invoked between the IPOP server and the IPOP database and the service performed. The interfaces classes which are used as the Accessors are independent of persistence or communication modes/protocols. With the Accessors, the requester program APIS are provided with connection management, security, transport details for handling remote method invocations (i.e., the I/O, in effect, for the distributed system) and the distribution for the applications. The request is instantiated as an action object that is both protocol-independent and network-route-unaware. The action object is addressed to the target resource, and the distributed framework routes the action object through the system so that the appropriate gateway receives the action object and ensures its completion and the return of status from its execution. The distributed nature of the gateways and their services allow logical routes to be dynamically determined for the action objects. As hardware and/or software changes or failures occur, the action objects can be rerouted, thereby providing fault-tolerance within the system. In particular, the present invention is directed to a plurality of access mechanisms by which distributed services objects and related property data are stored and are accessed within a distributed data processing system. The access mechanisms include an IP Driver IPOP Accessor; a Network Endpoint Locator IPOP Accessor, an Application Properties IPOP Accessor; and an Activator IPOP Accessor.

### BRIEF DESCRIPTION OF THE DRAWINGS

The invention will now be described in greater detail with specific reference to the appended drawings wherein:

FIG. 1 is a diagram depicting a known logical configuration of software and hardware resources;

FIG. 2 is simplified diagram illustrating a large distributed computing enterprise environment in which the present invention is implemented;

FIG. 3 is a block diagram depicting components within a distributed system installation that provide resource management functionality within a distributed computing environment in accordance with the present invention;

FIG. 4 is a block logic diagram of the IPOP (IP Object Persistence) service;

FIG. 5 is a flowchart that show processes for execution by the IP Driver IPOP Accessor;

FIG. 6 is a flowchart that shows processes for execution by the Network Endpoint Locator IPOP Accessor;

FIG. 7 is a flowchart that shows processes for execution by the Application Properties IPOP Accessor;

FIG. 8 is a flowchart that shows processes for execution by the Activator IPOP Accessor.

### DETAILED DESCRIPTION OF THE INVENTION

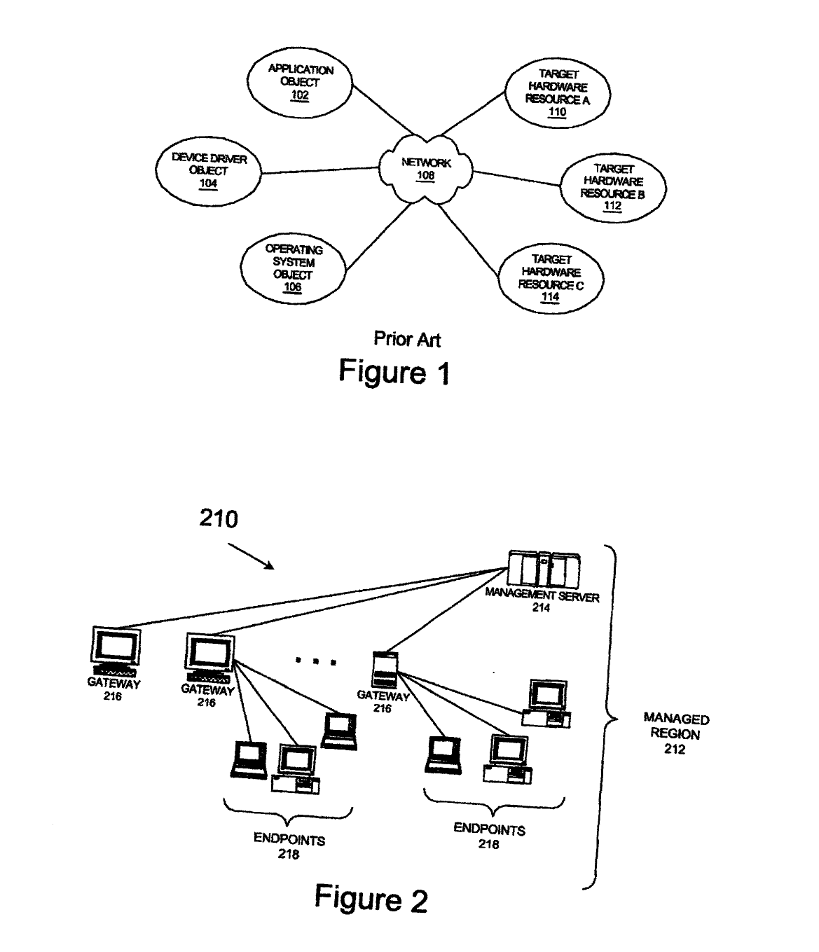

With reference now to FIG. 1, a diagram depicts a known logical configuration of software and hardware resources. In this example, the software is organized in an object-oriented system. Application object 102, device driver object 104, and operating system object 106 communicate across network 108 with other objects and with hardware resources 110-114.

In general, the objects require some type of processing, input/output, or storage capability from the hardware resources. The objects may execute on the same device to which the hardware resource is connected, or the objects may be physically dispersed throughout a distributed computing environment. The objects request access to the hardware resource in a variety of manners, e.g. operating system calls to device drivers. Hardware resources are generally available on a first-come, first-serve basis in conjunction with some type of arbitration scheme to ensure that the requests for resources are fairly handled. In some cases, priority may be given to certain requesters, but in most implementations, all requests are eventually processed.

With reference now to FIG. 2, the present invention is preferably implemented in a large distributed computer environment 210 comprising up to thousands of “nodes”. The nodes will typically be geographically dispersed and the overall environment is “managed” in a distributed manner. Preferably, the managed environment is logically broken down into a series of loosely connected managed regions (MRs) 212, each with its own management server 214 for managing local resources with the managed region. The network typically will include other servers (not shown) for carrying out other distributed network functions. These include name servers, security servers, file servers, thread servers, time servers and the like. Multiple servers 214 coordinate activities across the enterprise and permit remote management and operation. Each server 214 serves a number of gateway machines 216, each of which in turn support a plurality of endpoints/terminal nodes 218. The server 214 coordinates all activity within the managed region using a terminal node manager at server 214. Each gateway machine runs a server component of a system management framework. The server component is a multi-threaded runtime process that comprises several components including at least an object request broker (ORB), at least one service, and either a local object library or access to an object library. Preferably, ORBs runs continuously, separate from the operating system, and communicate with both server and client processes through separate stubs and skeletons via an interprocess communication (IPC) facility (not shown). In particular, a secure remote procedure call (RPC) is typically used to invoke operations on remote objects. A Gateway machine (e.g., 216) also includes an operating system and thread mechanism.

The system management framework, also termed distributed kernel services (DKS), includes a client component supported on each of the endpoint machines. The client component is a low cost, low maintenance application suite that is preferably “dataless” in the sense that system management data is not cached or stored there in a persistent manner. Implementation of the management framework in this “client-server” manner has significant advantages over the prior art, and it facilitates the connectivity of personal computers into the managed environment. It should be noted, however, that an endpoint may also have an ORB for remote object-oriented operations within the distributed environment, as explained in more detail further below.

Using an object-oriented approach, the system management framework facilitates execution of system management tasks required to manage the resources in the managed region. Such tasks are quite varied and include, without limitation, file and data distribution, network usage monitoring, user management, printer or other resource configuration management, and the like. In a preferred implementation, the object-oriented framework includes a Java runtime environment for well-known advantages, such as platform independence and standardized interfaces. Both gateways and endpoints operate portions of the system management tasks through cooperation between the client and server portions of the distributed kernel services.

In a large enterprise, such as the system that is illustrated in FIG. 2, there is preferably one server per managed region with some number of gateways. For a workgroup-size installation, e.g., a local area network, a single server-class machine may be used as both a server and a gateway. References herein to a distinct server and one or more gateway(s) should thus not be taken by way of limitation as these elements may be combined into a single platform. For intermediate size installations, the managed region grows breadth-wise, with additional gateways then being used to balance the load of the endpoints.

The server is the top-level authority over all gateways and endpoints. The server maintains an endpoint list, which keeps track of every endpoint in a managed region. This list preferably contains all information necessary to uniquely identify and manage endpoints including, without limitation, such information as name, location, and machine type. The server also maintains the mapping between endpoints and gateways, and this mapping is preferably dynamic.

Each endpoint is also a computing device. In one preferred embodiment of the invention, most of the endpoints are personal computers, e.g., desktop machines or laptops. In this architecture, the endpoints need not be high powered or complex machines or workstations. An endpoint computer preferably includes a Web browser such as Netscape Navigator or Microsoft Internet Explorer. An endpoint computer thus may be connected to a gateway via the Internet, an intranet or some other computer network.

Preferably, the client-class framework running on each endpoint is a low-maintenance, low-cost framework that is ready to do management tasks but consumes few machine resources because it is normally in an idle state. Each endpoint may be “dataless” in the sense that system management data is not stored therein before or after a particular system management task is implemented or carried out.

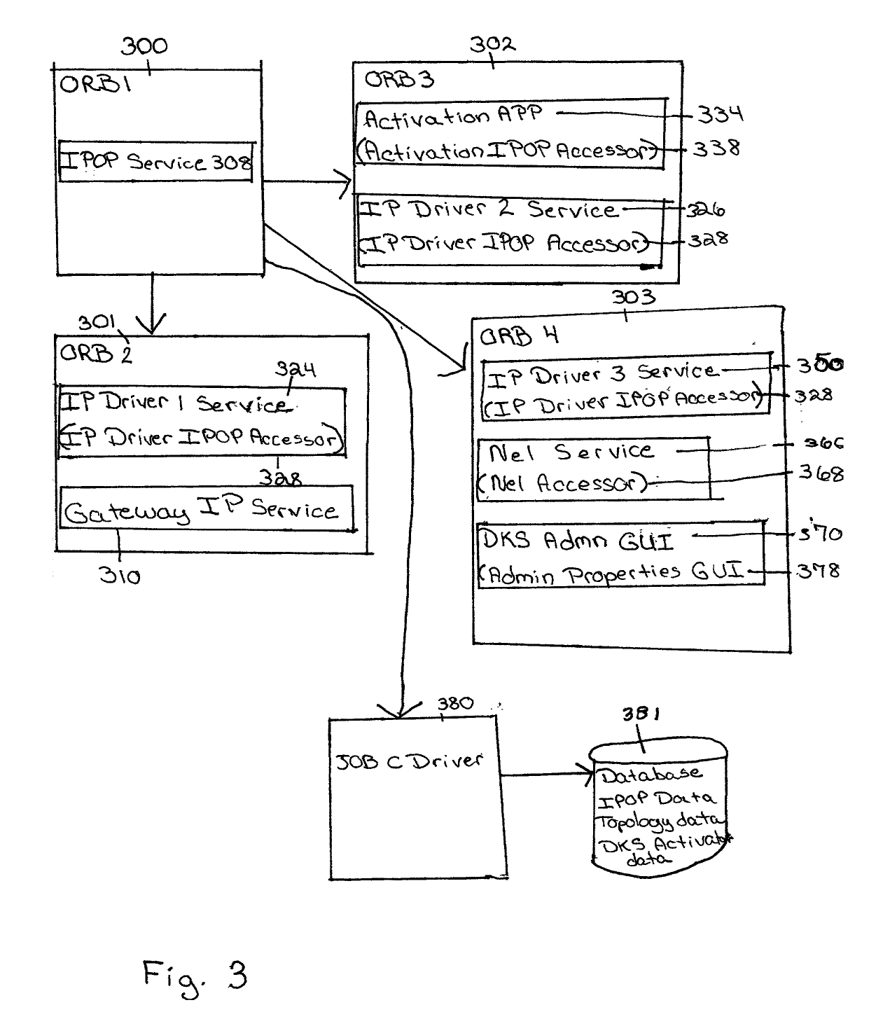

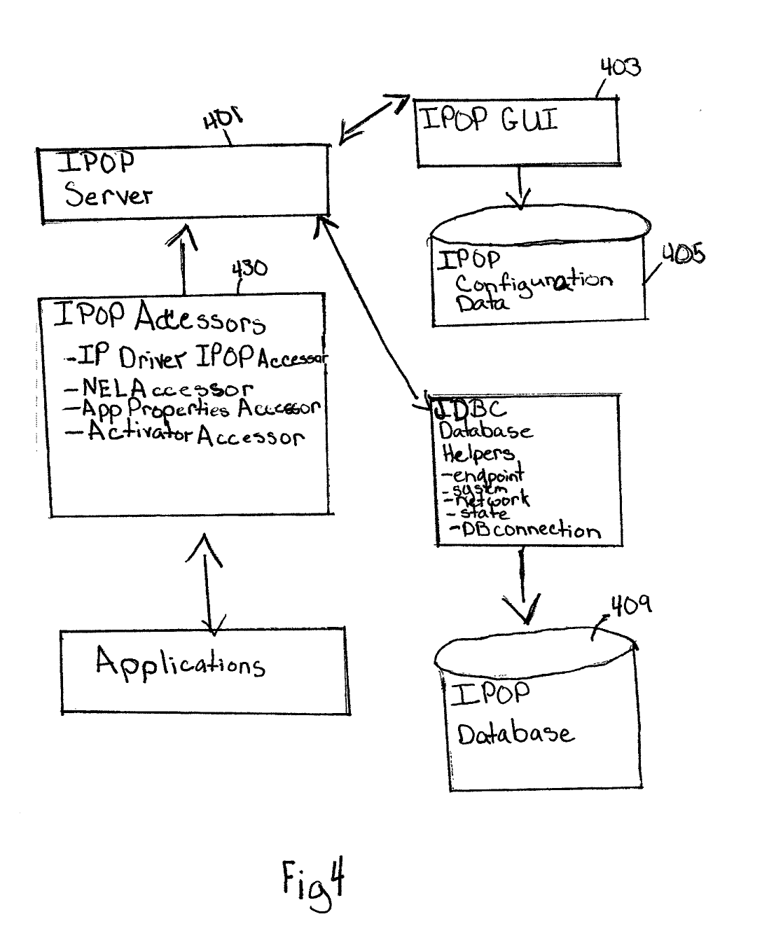

With reference now to FIG. 3, a block diagram depicts components within the system management framework that provide resource/service access functionality within a distributed computing environment such as that shown above. A network contains four (4) ORBs 300-303. IPOP Server 308 runs ORB1 300. In general, an ORB can support different services that are configured and run in conjunction with an ORB. For example, ORB4 at 301 includes IPDriver1 service 324 and Gateway IP Service 310.

The Gateway Service processes action objects, which are explained in more detail below, and directly communicates with endpoints or agents to perform management operations. The gateway receives events from resources and passes the events to interested parties within the distributed system. The NELS works in combination with action objects and determines which gateway to use to reach a particular resource. A gateway is determined by using the discovery service of the appropriate topology driver, and the gateway location may change due to load balancing or failure of primary gateways.

DKS does not impose any particular representation, but it does provide an object-oriented structure for applications to model resources. The use of object technology allows models to present a unified appearance to management applications and to hide the differences among the underlying physical or logical resources. Logical and physical resources can be modeled as separate objects and related to each other using relationship attributes. By using objects, for example, a system may implement an abstract concept of a router and then use this abstraction within a range of different router hardware. The common portions can be placed into an abstract router class while modeling the important differences in subclasses, including representing a complex system with multiple objects. With an abstracted and encapsulated function, the management applications do not have to handle many details for each managed resource. A router usually has many critical parts, including a routing subsystem, memory buffers, control components, interfaces, and multiple layers of communication protocols. Using multiple objects has the burden of creating multiple object identifiers (OIDs) because each object instance has its own OID. However, a first order object can represent the entire resource and contain references to all of the constituent parts.

ORB 301 contains IPDriver1 Service 324, for which the distributed IP Driver IPOP Accessor 328 will facilitate access. ORB 302 contains IPDriver2 Service 326, for which the distributed IP Driver IPOP Accessor 328 will also facilitate access, as well as Activation Application 328 for which the distributed Activator IPOP Accessor 338 will facilitate access. ORB 303 includes IPDriver3 Service 350 for which IP Driver IPOP Accessor 328 facilitates access, NEL Service 360, for which NEL IPOP Accessor 368 facilitates access, and the DKS Administration GUI 370 for which Application Properties IPOP Accessor 378 facilitates access. Also illustrated is the Data Access Server Service (e.g., JDBC device driver or other data access server service as appropriate) at 380 which connects the IPOP Server 300 to the native Database 381. DAS provides a database neutral access for application, wherein each ORB will have a DAS client (not shown) available as well. The Database 381 provides storage for the IPOP data, network topology data, DKS activator OID data, as well as other persistent objects, data, etc.

Applications require some type of insulation from the specifics of the operations of gateways. In the DKS environment, applications create action objects that encapsulate command which are sent to gateways, and the applications wait for the return of the action object. Action objects contain all of the information necessary to run a command on a resource. The application does not need to know the specific protocol that is used to communicate with the resource. The application is unaware of the location of the resource because it issues an action object into the system, and the action object itself locates and moves to the correct gateway. The location independence allows the NELS to balance the load between gateways independently of the applications and also allows the gateways to handle resources or endpoints that move or need to be serviced by another gateway. Nonetheless, the aforementioned Accessor components provide the transparent access mechanisms for access to the relevant applications/services, as further detailed below.

FIG. 4 is a block logic diagram of the IPOP (IP Object Persistence) service. The IPOP architecture includes the IPOP Manager for configuring the IPOP as well as the IPOP graphical user interface (GUI) for allowing system administrator input to IPOP configuration data, which is stored at the database shown at 405. The IPOP service utilizes the database helpers representatively illustrated as JDBC Database helpers at 407 and include those available code-customized representations for endpoint, system network, state and database connection management data. The IPOP database 409 provides storage of IP persistent objects, topology data, etc.

What the present invention provides, beyond the framework and IPOP service interactions disclosed in the co-pending patent applications, is a plurality of access mechanisms, shown in box 430, for DKS applications to access services, perform actions, and to read and write data at IP network resources. Each of the illustrated access mechanisms, or Accessors as they are dubbed by this disclosure, is available on a distributed basis as part of the IPOP Service. The access mechanisms illustrated in box 430, including an IP Driver IPOP Accessor; a Network Endpoint Locator (NEL) IPOP Accessor, an Application Properties IPOP Accessor; and an Activator IPOP Accessor, for facilitating the invoking and use of the IP Driver service (e.g., at ORB2, ORB3 and ORB4 of FIG. 3), NEL service (e.g., at ORB4 of FIG. 3), Application Properties service (e.g., at DKS Admin. GUI of ORB4 of FIG. 3), and Activation Application (e.g., at ORB3 of FIG. 3), respectively.

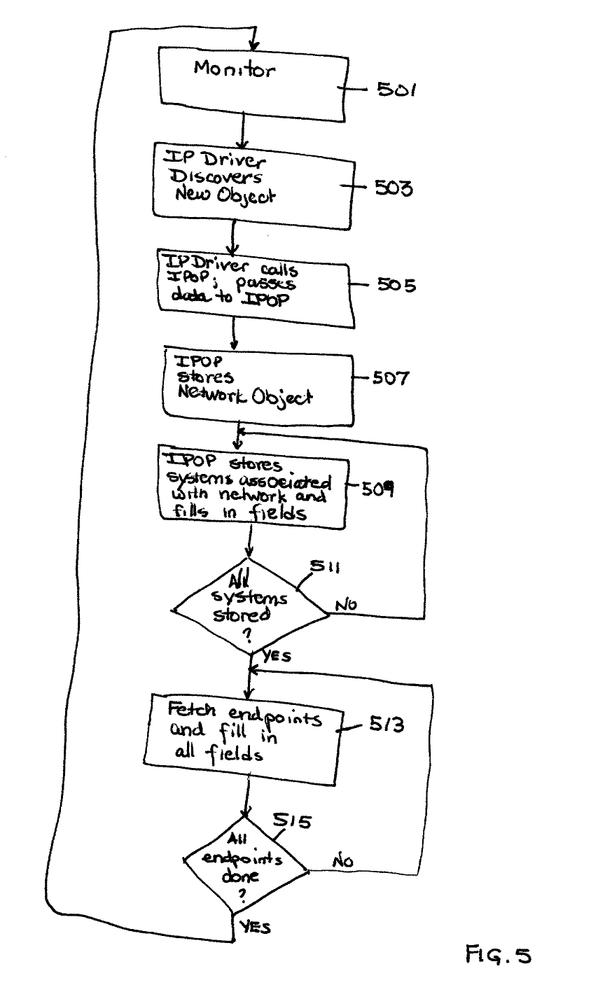

FIG. 5 is a flowchart that show processes for execution by the IP Driver IPOP Accessor. In the preferred embodiment of the present invention, an IP driver subsystem is implemented as a collection of software components for discovering, i.e. detecting, IP “objects”, i.e. IP networks, IP systems, and IP endpoints by using physical network connections. This discovered physical network is used to create topology data that is then provided through other services via topology maps accessible through a graphical user interface (GUI) or for the manipulation of other applications. The IP driver system can also monitor objects for changes in IP topology and update databases with the new topology information. The IPOP service provides the services for other applications to access the IP object database.

As detailed in FIG. 5, the IPDriver monitors at 501 and, upon discovery of a new object at 503, calls IPOP to store the network object and passes the network in memory to IPOP at 505. IPOP then stores the network object at 507, filling in all required fields. Next the IPOP stores all systems associated with the network with all fields at 509. Based upon a determination at 511 as to whether all systems have been fetched, the looping through system data continues at 509-511 or the system moves on to fetch all endpoints and fill in all fields for endpoints at 513. Once it has been determined that all endpoints have been fetched, at decision box 515, the IPDriver returns to its monitoring state.

The following pseudo-code illustrates the flow for the IP Driver IPOP Accessor:

IP Driver discovers a new Network Object

IP Driver calls IPOP API to persistently store then Network object in database. Passes the Network in memory to IPOP

IPOP stores network object in database

IPOP fetches prepared statement for Network Object and fills in the required fields based on the Network in memory passed by IPDriver

IPOP executes prepared statement in JDBC If no DB errors, continue

IPOP Stores all systems associated with Network in Database

Fetch systemsInNetwork vector from Network in memory

For each system LOOP

IPOP fetches database prepared statement for System and fills in the required fields based on the System in memory passed by IPDriver's Network

IPOP executes prepared statement in JDBC If no DB errors, continue

Fetch endpointsInSystem vector from System in memory

For each endpoint LOOP

IPOP fetches database prepared statement for Endpoint and fills in the required fields based on the Endpoint in memory passed by IPDriver's Network

IPOP executes prepared statement in JDBC If no DB errors, continue

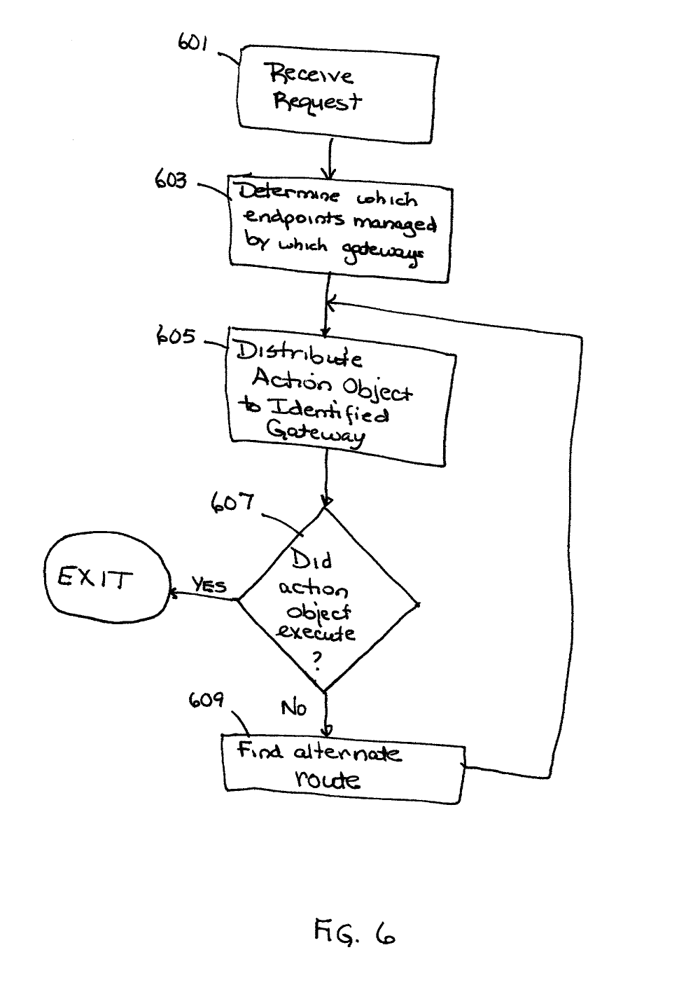

FIG. 6 is a flowchart that shows processes for execution by the Network Endpoint Locator IPOP Accessor. The Network Endpoint Locator (NEL) is used for application action access. The NEL service finds a route (data path) to communicate between the application and the appropriate endpoint. The NEL service converts input to protocol, network address, and gateway location for use by action objects. The NEL service is a thin service that supplies information discovered by the IPOP service. The primary roles of the NEL service are as follows: support the requests of applications for routes; maintain the gateway and endpoint caches that keep the route information; ensure the security of the requests; and perform the requests as efficiently as possible to enhance performance.

When an action needs to be taken on a set of endpoints based on a request at 601, the NEL service determines which endpoints are managed by which gateways at 603. When the appropriate gateway is identified, a single copy of the action object is distributed to each identified gateway at 605. The results from the endpoints are asynchronously merged back to the caller application through the appropriate gateways. Performing the actions asynchronously allows for tracking all results whether the endpoints are connected or disconnected. If the action object IP fails to execute an action object on the target gateway, as determined at 607, NEL is consulted to identify an alternative path for the command. If an alternate path is found at 609, the action object IP is transported to that gateway at 605 and executed. It may be assumed that the entire set of commands within one action object IP must fail before this recovery procedure is invoked.

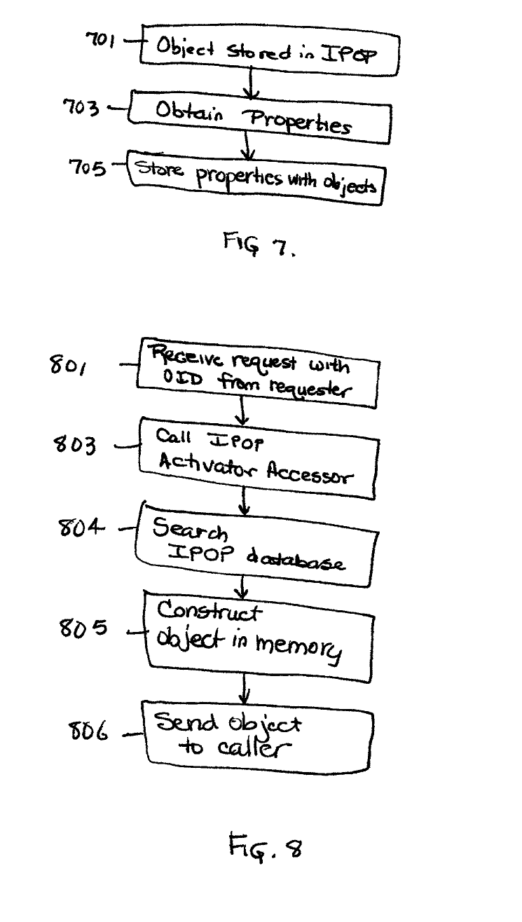

FIG. 7 is a flowchart that shows processes for execution by the Application Properties IPOP Accessor. When physical network objects are stored in IPOP at 701, the Application Properties IPOP Accessor will obtain properties at 703 and store the textual property information with the physical network objects at 705. Properties, such as a simple identification of “Mary's computer” or “John's router” may become valuable tools on which to sort or use programatically at a later date.

FIG. 8 is a flowchart that shows processes for execution by the Activator IPOP Accessor. Applications request object using IPOP OIDs, for ease of communications, minimal storage requirements, etc. The Activation Service can take the OIDs in a request, provide the data class, and return the full object with related properties, etc. to the caller. In that way a locally stored application need only maintain a list of integers (i.e., OIDs) from which the Activator will reconstruct objects and provide the objects to the caller for application use. As shown in FIG. 8, upon receipt of a request having an OID at 801, the Activator IPOP Accessor is called at 803. The Activator IPOP Accessor searcher the IPOP database at 804, constructs the object in memory at 805 and then send the object to the caller at 806.

Each of the Accessor components provides the functionality for a requester, which requester has the APIs for services, to call a service by which a connection is invoked between the IPOP server and the IPOP database and the service performed. The interfaces classes which are used as the Accessors are independent of persistence or communication modes/protocols. With the Accessors, the program APIS are provided with connection management, security, transport details for handling remote method invocations (i.e., the I/O, in effect, for the distributed system) and the distribution for the applications.

The advantages of the present invention should be apparent in view of the detailed description of the invention that is provided above. A distributed data processing system can be managed using a gateway-endpoint organization that allows for a highly distributed service management architecture. Services within this framework enable resource consumers to address resources and use resources throughout the distributed system.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for managing resources within a distributed data processing network having a plurality of distributed services for use by at least one network requester, the method comprising the steps of:
providing a plurality of access mechanisms between the distributed service and a network requester; and
activating at least one of said access mechanisms in response to a request from said network requester.

2. The method of claim 1 wherein said plurality of access mechanisms operate independent of the communication protocol utilized by said at least one network requester.

3. The method of claim 2 wherein each of said at least one network requester comprises at least one application programming interface (API) for at least one service and wherein said activating comprises invoking at least one of said access mechanisms to call a service by which a connection is invoked between a server and a server-associated persistent storage database.

4. The method of claim 3 further comprising the step of performing said service.

5. The method of claim 3 wherein said plurality of access mechanisms provide at least one of connection management, security, transport details for handling remote method invocations, and distribution for said at least one API.

6. The method of claim 2 wherein said at least one access mechanism comprises an IP Driver Accessor for performing discovery and status monitoring in said network.

7. The method of claim 2 wherein said at least one access mechanism comprises a Network Endpoint Locator Accessor for locating at least one endpoint in said network.

8. The method of claim 3 wherein said at least one access mechanism comprises an Application Properties Accessor for updating said persistent storage database.

9. The method of claim 3 wherein said at least one access mechanism comprises an Activator Accessor for accessing objects stored in said persistent storage database based on said request.

10. The method of claim 9 wherein said request includes an integer comprising an object identifier.

11. A resource management system for managing resources within a distributed data processing network having a plurality of distributed services for use by at least one network requester, the method comprising:
a plurality of access mechanisms between the distributed service and a network requester; and
at least one response component for activating at least one of said access mechanisms in response to a request from said network requester.

12. The system of claim 11 wherein said plurality of access mechanisms operate independent of the communication protocol utilized by said at least one network requester.

13. The system of claim 12 wherein each of said at least one network requester comprises at least one application programming interface (API) for at least one service and wherein said at least one response component comprises means for invoking at least one of said access mechanisms to call a service by which a connection is invoked between a server and a server-associated persistent storage database.

14. The system of claim 13 wherein said plurality of access mechanisms provide at least one of connection management, security, transport details for handling remote method invocations, and distribution for said at least one API.

15. The system of claim 12 wherein said at least one access mechanism comprises an IP Driver Accessor for performing discovery and status monitoring in said network.

16. The system of claim 12 wherein said at least one access mechanism comprises a Network Endpoint Locator Accessor for locating at least one endpoint in said network.

17. The system of claim 13 wherein said at least one access mechanism comprises an Application Properties Accessor for updating said persistent storage database.

18. The system of claim 13 wherein said at least one access mechanism comprises an Activator Accessor for accessing objects stored in said persistent storage database based on said request.

19. A program storage device readable by machine tangibly embodying a program of instructions executable by the machine for performing a method for managing resources within a distributed data processing network having a plurality of distributed services for use by at least one network requester, the method comprising the steps of:
providing a plurality of protocol-independent access mechanisms between the distributed service and a network requester, adapted to operate independent of the communication protocol utilized by said at least one network requester; and
activating at least one of said access mechanisms in response to a request from said network requester.

20. The program storage device of claim 19 wherein each of said at least one network requester comprises at least one application programming interface (API) for at least one service and wherein said activating comprises invoking at least one of said access mechanisms to call a service by which a connection is invoked between a server and a server-associated persistent storage database.
